(19) United States
(12) Patent Application Publication
(10) Pub. No.: US 2021/0329862 A1
(43) Pub. Date: Oct. 28, 2021

(54) INTELLIGENT CULTIVATION APPARATUS, METHOD AND SYSTEM

(71) Applicant: BOE TECHNOLOGY GROUP CO., LTD., Beijing (CN)

(72) Inventor: Xinyi CHENG, Beijing (CN)

(73) Assignee: BOE TECHNOLOGY GROUP CO., LTD., Beijing (CN)

(21) Appl. No.: 16/471,247

(22) PCT Filed: Dec. 20, 2018
(86) PCT No.: PCT/CN2018/122391

§ 371 Date: Jun. 19, 2019

(30) Foreign Application Priority Data
Feb. 2, 2018 (CN) 201810106695.X

(51) Int. Cl. A01G 25/16; A01G 7/00; A01C 21/00; G05B 13/02

(52) U.S. Cl. CPC A01G 25/167; G05B 13/024; A01C 21/007; A01G 7/00

(57) ABSTRACT

An intelligent cultivation apparatus includes a sensor, configured to measure plants cultivation environment parameter data; a controller, configured to generate plants cultivation status information based at least on the measured plants cultivation environment parameter data; and a cultivation suggestion generator, configured to generate a targeted cultivation suggestion based at least on a plants cultivation database and the plants cultivation status information. The intelligent cultivation apparatus further includes a camera configured for capturing images of the plants, wherein the cultivation suggestion generator generates the targeted cultivation suggestion based on the images of the plants, the plants cultivation database and the plants cultivation status information. The cultivation suggestion generator further configured to combine the targeted cultivation suggestion with the plants cultivation status information, for adjusting calculating parameters of the cultivation suggestion generator and updating the plants cultivation database.

This application claims the priority of Chinese Patent Application No. 201810106695.X, filed on Feb. 2, 2018, which is hereby incorporated by reference in its entirety as a part of this application.

### TECHNICAL FIELD

The present disclosure relates to the field of intelligent household control system, and more particularly to an intelligent cultivation apparatus, an intelligent cultivation method and an intelligent cultivation system.

### BACKGROUND

The existing intelligent cultivation systems generally adopt temperature and humidity sensors to monitor soil temperature and humidity, or automatically water plants based on “Internet+”, but they have single function and poor intelligence, it is not possible to intelligently provide targeted cultivation suggestions with respect to the cultivation status for currently cultivated plants, failing to meet the needs of users for true intelligent cultivation.

### SUMMARY

The present disclosure provides an intelligent cultivation apparatus, method and system, the intelligent cultivation apparatus comprises a sensor, a controller and a cultivation suggestion generator, the cultivation suggestion generator generates a targeted cultivation suggestion on plants cultivation based at least on a plants cultivation database and the plants cultivation status information calculated by the controller, the controller intelligently cultivate based on the targeted cultivation suggestion, thereby realizing cultivation of plants based on common data of plants cultivation and actual conditions so as to achieve the effect of intelligent automatic cultivation.

The embodiments of the present disclosure provide an intelligent cultivation apparatus comprising: a sensor that measures plants cultivation environment parameter data; a controller that generates plants cultivation status information based at least on the measured plants cultivation environment parameter data; and a cultivation suggestion generator that generates a targeted cultivation suggestion based at least on a plants cultivation database and the plants cultivation status information.

According to an embodiment of the present disclosure, the intelligent cultivation apparatus further comprises a camera for capturing images of the plants, wherein the cultivation suggestion generator generates the targeted cultivation suggestion based on the images of the plants, the plants cultivation database and the plants cultivation status information.

According to an embodiment of the present disclosure, the cultivation suggestion generator further combines the targeted cultivation suggestion with the plants cultivation status information, for adjusting calculating parameters of the cultivation suggestion generator and updating the plants cultivation database.

According to an embodiment of the present disclosure, the sensor includes one or more of a temperature sensor, a humidity sensor, a light intensity sensor and a soil nutrient sensor; the plants cultivation database includes at least one of a plants growth cycle, a suitable temperature, a suitable humidity, a suitable light intensity, a suitable soil parameter, a required nutrient component, a watering parameter and a fertilizing parameter; the controller further controls a water reservoir to water plants and/or controls a fertilizer applicator to fertilize plants based on the targeted cultivation suggestion.

According to an embodiment of the present disclosure, the intelligent cultivation apparatus further comprises: a wireless communication device that includes a first operating mode and a second operating mode: in the first operating mode, the wireless communication device is connected, as a wireless access point, to a user terminal so that the wireless communication device is configured through the user terminal; in the second operating mode, the wireless communication device is connected to a cloud server, for downloading the plants cultivation database and uploading an updated plants cultivation database.

According to an embodiment of the present disclosure, the intelligent cultivation apparatus further comprises a display screen.

According to an embodiment of the present disclosure, the sensor includes a first humidity sensor and a second humidity sensor, at a first moment in the watering process, first humidity data is measured at a first location by using the first humidity sensor; at a second moment in the watering process, second humidity data is measured at a second location by using the second humidity sensor; a water absorption rate of the soil is calculated by using the controller based on the first humidity data, the second humidity data, a distance between the first location and the second location as well as a time interval between the first moment and the second moment, as the plants cultivation status information; a targeted cultivation suggestion on watering is generated by using the cultivation suggestion generator based on the plants cultivation database and the water absorption rate of the soil.

According to an embodiment of the present disclosure, the sensor further includes a third humidity sensor and a first temperature sensor, at a third moment after watering, third humidity data is measured by using the third humidity sensor; at a fourth moment after watering, fourth humidity data is measured by using the third humidity sensor; temperature data after watering is measured by using the first temperature sensor; a drying rate of the soil is calculated by using the controller based on the third humidity data, the fourth humidity data, a time interval between the third moment and the fourth moment as well as the temperature data, as the plants cultivation status information; a targeted cultivation suggestion on a watering amount is generated by using the cultivation suggestion generator based on the plants cultivation database, the water absorption rate of the soil and the drying rate of the soil.

The embodiments of the present disclosure also provide an intelligent cultivation method for the intelligent cultivation apparatus mentioned above. The intelligent cultivation method comprises: measuring, by a sensor, plants cultivation environment parameter data; generating, by a controller, plants cultivation status information based at least on the measured plants cultivation environment parameter data; and generating, by a cultivation suggestion generator, a targeted cultivation suggestion based at least on a plants cultivation database and the plants cultivation status information.

According to an embodiment of the present disclosure, the intelligent cultivation method further comprises capturing, by a camera, images of the plants, wherein the cultivation suggestion generator generates the targeted cultivation suggestion based on the images of the plants, the plants cultivation database and the plants cultivation status information.

According to an embodiment of the present disclosure, the intelligent cultivation method further comprises: combining, by the cultivation suggestion generator, the targeted cultivation suggestion with the plants cultivation status information, for adjusting a calculating parameter of the cultivation suggestion generator and updating the plants cultivation database.

According to an embodiment of the present disclosure, the intelligent cultivation method further comprises: acquiring, by a wireless communication device, from a wireless network, geographical location information of the intelligent cultivation apparatus and season information for cultivation, wherein the cultivation suggestion generator generates a targeted cultivation suggestion on plants growth based on the plants cultivation database, the plants cultivation status information as well as the geographic location information and the season information.

According to an embodiment of the present disclosure, the plants cultivation database includes at least one of a plants growth cycle, a suitable temperature, a suitable humidity, a suitable light intensity, a suitable soil parameter, a required nutrient component, a watering parameter and a fertilizing parameter; the targeted cultivation suggestion includes at least one of a suitable temperature range, a suitable humidity range, a watering period, a watering amount, a watering flow rate, a watering frequency, a nutrient solution applying amount, a fertilizing suggestion, a water absorption of the soil, a suitable soil, an illumination period and a suitable cultivation vessel size for plants cultivation in practice, wherein the controller controls a water reservoir to water plants and/or controls a fertilizer applicator to fertilize plants based on the targeted cultivation suggestion.

According to an embodiment of the present disclosure, the intelligent cultivation method further comprises: connecting the wireless communication device to a cloud server, for downloading the plants cultivation database and uploading an updated plants cultivation database.

According to an embodiment of the present disclosure, the intelligent cultivation method further comprises: transmitting, by the wireless communication device, to a user terminal, the plants cultivation status information generated by the controller and/or the targeted cultivation suggestion generated by the cultivation suggestion generator.

According to an embodiment of the present disclosure, the intelligent cultivation method further comprises: receiving, by the wireless communication device, an electronic album transmitted from the user terminal; and controlling, by the controller, a display screen to display the electronic album transmitted from the user terminal.

According to an embodiment of the present disclosure, the intelligent cultivation method further comprises: receiving, by the wireless communication device, from the cloud server, data transmitted from the user terminal to the cloud server, and/or directly receiving data from the user terminal.

According to an embodiment of the present disclosure, the intelligent cultivation method further comprises: receiving, by the wireless communication device, a command transmitted from the user terminal to water and/or fertilize plants; and controlling, by the controller, the water reservoir to water plants and/or the fertilizer applicator to fertilize plants, according to the command received by the wireless communication device.

The embodiments of the present disclosure further provide an intelligent cultivation system comprising the intelligent cultivation apparatus mentioned above, and further comprising a user terminal, the user terminal communicating with the intelligent cultivation apparatus over a wireless network.

According to an embodiment of the present disclosure, the intelligent cultivation system further comprises a cloud server, the cloud server communicating with the intelligent cultivation apparatus and the user terminal over a wireless network.

### BRIEF DESCRIPTION OF THE DRAWINGS

In order to more clearly illustrate the technical solutions in the embodiments of the present disclosure, drawings necessary for describing the embodiments will be briefly introduced below, obviously, these described drawings are only related to some embodiments of the present disclosure and thus are not limitative of the present disclosure.

FIG. 1 shows a system diagram of an intelligent cultivation apparatus according to an embodiment of the present disclosure;

FIG. 2 shows a system configuration diagram of an intelligent cultivation apparatus according to an embodiment of the present disclosure;

FIG. 3 shows a schematic diagram of operations of a wireless communication device according to an embodiment of the present disclosure;

FIG. 4 shows a flow chart of initialization of an intelligent cultivation apparatus according to an embodiment of the present disclosure;

FIG. 5 shows a schematic diagram of detecting a water absorption rate by using a humidity sensor according to an embodiment of the present disclosure;

FIG. 6 shows a flow chart of detecting a water absorption rate by using a humidity sensor according to an embodiment of the present disclosure;

FIG. 7 shows a flow chart of calculating a drying rate of the soil according to an embodiment of the present disclosure;

FIG. 8 shows a flow chart of an intelligent cultivation method according to an embodiment of the present disclosure;

FIG. 9 shows a flow chart of generating a targeted cultivation suggestion according to an embodiment of the present disclosure; and

FIG. 10 shows a flow chart of intelligently cultivating plants based on geographic location and season according to an embodiment of the present disclosure.

### DETAILED DESCRIPTION OF THE EMBODIMENTS

Hereinafter, the technical solutions in the embodiments of the present disclosure will be described clearly and comprehensively in combination with the drawings thereof, obviously, these described embodiments are only parts of the embodiments of the present disclosure, rather than all of the embodiments thereof. All the other embodiments obtained by those of ordinary skill in the art based on the embodiments of the present disclosure without paying creative efforts fall into the protection scope of the present disclosure.

The embodiments of the present disclosure provide an intelligent cultivation apparatus, method and system for intelligently cultivating plants based on the targeted cultivation suggestion. The intelligent cultivation apparatus, method and system use a sensor to measure plants cultivation environment parameter data, and use a controller to generate plants cultivation status information based on the measured plants cultivation environment parameter data, thereby generating a targeted cultivation suggestion by using the cultivation suggestion generator based on the plants cultivation database and the plants cultivation status information. Based on the targeted cultivation suggestion, the intelligent cultivation apparatus can realize intelligent automatic cultivating of plants, and the intelligent cultivation apparatus, method and system can also realize communication with users by using a wireless communication device, feed the targeted cultivation suggestion back to users, and cultivate plants according to user commands received.

For example, the intelligent cultivation apparatus provided by the embodiments of the present disclosure may be configured for planting flowers, ornamental potted plants and others. Next, specific implementations of the intelligent cultivation apparatus, method and system according to the present disclosure will be described in detail by taking intelligent planting flowers as an example.

A system diagram of the intelligent cultivation apparatus 100 provided by an embodiment of the present disclosure shown in FIG. 1, may comprise a sensor 101, a controller 102 and a cultivation suggestion generator 103. In the intelligent cultivation apparatus, the sensor is configured to measure flowers cultivation environment parameter data, wherein the flowers cultivation environment parameter data serves as plants cultivation environment parameter data. For example, the sensor may include one or more of a temperature sensor, a humidity sensor, a light intensity sensor and a soil nutrient sensor. It should be noted that the sensor may also include other sensors for detecting information required for flowers cultivation so as to improve automatic ability and intelligence level of the intelligent cultivation apparatus for flowers.

In the intelligent cultivation apparatus, the temperature sensor may be configured to detect soil temperature information and ambient temperature information. The humidity sensor may be configured to detect soil humidity information. The light intensity sensor may be configured to detect parameters such as ambient light intensity, illumination direction and illumination time. And the soil nutrient sensor may be configured to detect a proportion of nutrients such as nitrogen, phosphorus and potassium in the soil. Based on the information detected by the aforesaid sensors, the cultivation suggestion generator may generate a suggestion on automatic watering or watering reminder, a suggestion on flowers illumination, and a suggestion on fertilization by determining soil nutrient status.

The controller in the intelligent cultivation apparatus may be configured to generate flowers cultivation status information based at least on the measured flowers cultivation environment parameter data, wherein the flowers cultivation status information serves as plants cultivation status information. The flowers cultivation environment parameter data is various types of information on flowers cultivation measured by the above sensor, and the detected information is calculated or processed to generate the flowers cultivation status information, for example, a water absorption rate of the soil, a drying curve of the soil, etc. The controller may include a controller as well as a peripheral circuit or the like, for implementing a control function for the sensor, such as controlling the temperature sensor to periodically detect the ambient temperature and so on.

The cultivation suggestion generator in the intelligent cultivation apparatus is an expert system, the expert system is configured for generating a targeted cultivation suggestion based at least on a flowers cultivation database and the flowers cultivation status information, wherein the flowers cultivation database serves as a plants cultivation database. The flowers cultivation database may include common data on flowers cultivation, for example, it may include a flowers growth cycle, a suitable temperature, a suitable humidity, a suitable light intensity, a suitable soil parameter, a required nutrient component, a watering parameter and a fertilizing parameter etc., which data may be stored in a storage device of the local intelligent cultivation apparatus, or downloaded from a cloud server to the intelligent cultivation apparatus after the intelligent cultivation apparatus completes the initialization setting.

The expert system may be set in the controller, and may also be set in the user terminal or in the cloud server.

The targeted cultivation suggestion may include a suitable temperature range, a suitable humidity range, a watering period, a watering amount, a watering flow rate, a watering frequency, a nutrient solution applying amount, a fertilizing suggestion, water absorption of soil, a suitable soil, an illumination period and a suitable cultivation vessel size etc. for flowers cultivation in practice. For example, the cultivation suggestion generator can generate a targeted cultivation suggestion on an amount of applied nutrient solution based on the data regarding the nutrient solution required for the cultivated flowers in the flowers cultivation database, in conjunction with the actual data of soil nutrients detected by the sensor. And, according to parameters such as the flowers growth status and the soil nutrient absorption detected after application of the nutrient solution, the cultivation suggestion generator can continuously adjust the parameter for calculating the targeted cultivation suggestion so as to generate a cultivation suggestion more suitable for flowers growth. Therefore, the intelligent cultivation apparatus can realize intelligent flowers cultivation according to the actual environment conditions in the flowers growing process, instead of mechanically following the data in the database.

The intelligent cultivation apparatus may be, for example, an intelligent flower pot, wherein optionally, components such as the sensor, the controller and the cultivation suggestion generator mentioned above may be configured, and the components included in the flower pot may be integrally designed to meet the needs of intelligent flowers cultivation. The intelligent cultivation apparatus may also be, for example, an intelligent flowers house or an intelligent flowers shed or the like.

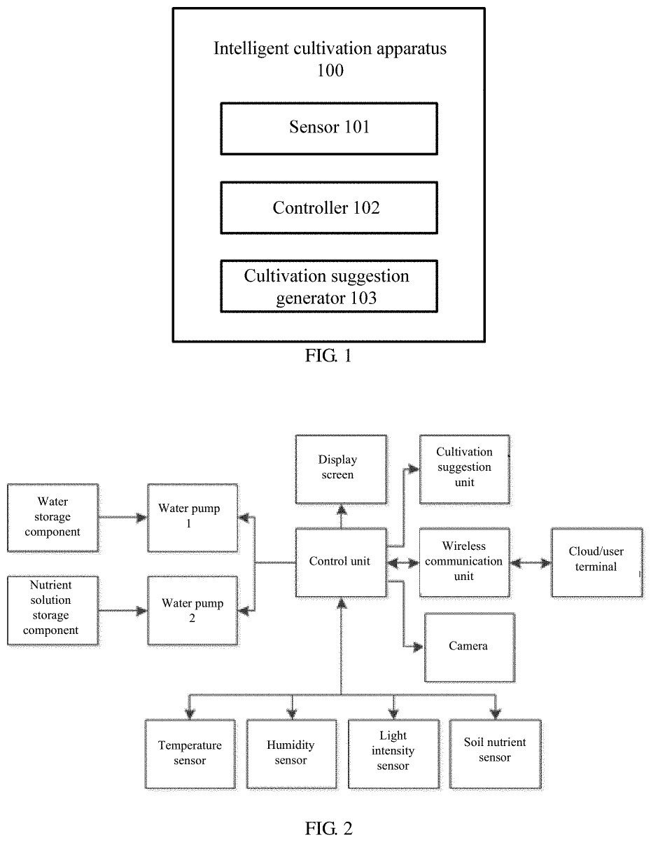

FIG. 2 shows a system configuration diagram of an intelligent cultivation apparatus according to an embodiment of the present disclosure. Composition and function of the intelligent cultivation apparatus will be described in detail below with reference to FIG. 2.

In the embodiment of the present disclosure shown in FIG. 2, the intelligent cultivation apparatus further comprises at least some of components among a camera, a display screen, a water storage component, a water pump, a nutrient solution storage component and a wireless communication device etc., so as to implement the function of automatic intelligent flowers cultivation. The camera can capture image (or video) data of flowers or cultivation environments, wherein the images of the flowers serves as images of plants. Through the captured images of the flowers, the intelligent cultivation apparatus can automatically complete recognition of the species and the cultivation status of the flowers.

For example, size, status, and the like of the flowers may be obtained by image processing. Based on the status information such as yellow leaves and dryness of the flowers obtained by image recognition, in conjunction with the data of such flowers in the flowers cultivation database and the flowers cultivation status information generated by the controller, the cultivation suggestion generator can determine the reason of yellow leaves of the flowers, and give a targeted cultivation suggestion. For example, flowers growth is recognized through the images, when the flowers grows too large, the cultivation suggestion generator may generate a cultivation suggestion of replacing a larger pot for the flowers, thus realizing the function of intelligent flowers cultivation.

The display screen may be a flexible display screen that fits on a surface of the intelligent cultivation apparatus, for example, the surface of the flower pot, the flowers status information may be displayed through the display screen, so that the user can view the growth status of the flowers in real time through the display screen. The display screen may also display the images of the flowers captured by the camera, so that the user can browse the growth process of the flowers, and switch the displayed picture through a touch interaction on the touch screen. The display screen may also be configured as an electronic album to display photos and realize the function of desktop decoration. According to another embodiment of the present disclosure, the display screen may be a display screen inside or outside the intelligent flowers house or the intelligent flowers shed, configured for, for example, displaying images of the flowers.

The water storage component stores water. The water storage component and the water pump 1 together constitute a water reservoir, for realizing automatic watering for the flowers. The nutrient solution storage component stores a liquid fertilizer, the nutrient solution storage component and the water pump 2 together constitute a fertilizer applicator for realizing automatic fertilization for the flowers. According to the targeted cultivation suggestion generated by the cultivation suggestion generator, the controller in the intelligent cultivation apparatus can control the watering device to water the flowers and control the fertilizer applicator to fertilize, thereby realizing automatic cultivation. The water storage component and the nutrient solution storage component are provided with a minimum liquid level sensor for detecting a water level or a storage amount of the nutrient solution, and when there is a water shortage or a lack of fertilization, the cultivation suggestion generator may generate, based on the detected data, a cultivation suggestion of a reminder to add water or add fertilizer.

The cultivation suggestion generator can generate a targeted cultivation suggestion based on the information in the flowers cultivation database and the flowers cultivation status information generated by the controller, or generate a targeted cultivation suggestion based on the flowers cultivation database, the flowers cultivation status information and the image of the flowers captured by the camera. Therefore, the generated targeted cultivation suggestion is generated based on the common data of flowers cultivation and the actual cultivation status, and can be more reasonably applied to the current cultivation status, thereby achieving more intelligent cultivation effects. In addition, the cultivation suggestion generator can further continuously adjust the calculating parameter of the cultivation suggestion generator in combination with the data measured by the sensor after the flowers is cultivated according to the targeted cultivation suggestion, and update the information in the flowers cultivation database, thus forming an intelligent cultivation process that makes continuous feedback and corrects parameters based on actual conditions.

According to an embodiment of the present disclosure, the process of adjusting the calculating parameter may be, for example, in an initial stage of cultivation, the cultivation suggestion generator searches in the flowers cultivation database for cultivation data of the flowers according to the input flowers information, and uses the data as initial calculating parameters for generating the cultivation suggestion, for example, including growth characteristics of the flowers, the parameters such as ambient light intensity, temperature, humidity, soil type suitable for growth of the flowers, watering and fertilizing thresholds. The cultivation suggestion generator generates a cultivation suggestion based on the initial calculating parameters, and the controller controls water storage of the water reservoir and controls fertilization of the fertilizer applicator according to the generated cultivation suggestion.

During the cultivation process, the intelligent cultivation apparatus will use the sensor to detect in real time the information such as light intensity, temperature and humidity information of the environments, temperature and humidity of the soil. For example, after the controller controls the water reservoir to water the flowers based on the generated cultivation suggestion, the humidity sensor can detect a change of the soil humidity at different locations during the watering, and the soil humidity after the watering, and the controller calculates the flowers cultivation status information based on the above measured data, such as a water absorption rate of the soil, a drying rate of the soil and other parameters. The cultivation suggestion generator adjusts the calculating parameters thereof by referring to the watering cultivation suggestion and the flowers cultivation status information calculated based on the watering. For example, the calculating parameter is adjusted by determining whether the cultivation suggestion is suitable for the current cultivation environments, thereby generating a targeted cultivation suggestion, including a watering period, a watering flow rate, a watering amount, a watering frequency, and the like. Thus, the intelligent cultivation apparatus can generate a more targeted cultivation suggestion by continuously adjusting the calculating parameters for generating the cultivation suggestion.

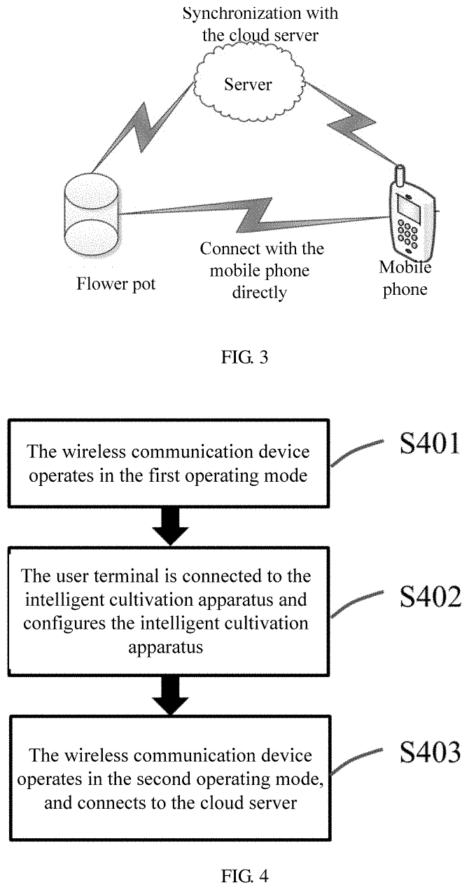

As shown in FIG. 3, the intelligent cultivation apparatus (e.g., an intelligent flower pot) may be connected to a user terminal (e.g., a mobile phone) or to a cloud server using a wireless communication device. The wireless communication device may include a first operating mode and a second operating mode. In the first operating mode, the wireless communication device as a wireless access point is directly connected to the user terminal, and the user terminal may perform initial setting on the wireless communication device. In the second operating mode, the wireless communication device is connected to the cloud server via the network, for downloading the flowers cultivation database and uploading an updated flowers cultivation database. The wireless communication device may further receive data uploaded by the user terminal (e.g., a watering command or an electronic album) from the cloud server, and transmit information such as a cultivation suggestion (e.g., replacing a flower pot or suitable soil) to the user terminal through the cloud server.

According to an embodiment of the present disclosure, the intelligent cultivation apparatus may complete the initial setting by the first operating mode and the second operating mode of the wireless communication device when initially used. FIG. 4 shows a flowchart of initialization of an intelligent cultivation apparatus, wherein in step S401, at an initial use of the intelligent cultivation apparatus, the wireless communication device first operates in the first operating mode and is connected to the user terminal directly as an access point. Next, in step S402, the user terminal may configure the intelligent cultivation apparatus through an installed application, and set system information (e.g., WiFi settings and system account number and other information) so that it can connect to the network. In step S403, the already-set wireless communication device operates in the second operating mode, for example, the wireless network such as a router may be connected through a user mode, for downloading the flowers cultivation database required for the current cultivated flowers from the cloud server, or uploading the flowers cultivation database updated by the cultivation suggestion generator, or being connected to the user terminal via the cloud server. In addition, the already-set wireless communication device may not be connected to the cloud server but directly connected to the user terminal. The wireless communication device connected to the user terminal can feed back the flowers cultivation status information and the cultivation suggestion to the user. The user terminal connected to the wireless communication device can transmit a command or an electronic album to the intelligent cultivation apparatus. For example, the user terminal can remotely synchronize the status information of the intelligent flower pot through the application program, and control automatic watering and fertilizing of the flowers by transmitting a command thereto, can also push pictures remotely to display on the display screen of the intelligent cultivation apparatus.

The intelligent cultivation apparatus may also be connected to the cultivation suggestion generator through the wireless communication device (not shown in FIG. 2), so that the process of generating the targeted cultivation suggestion by the cultivation suggestion generator can be performed in the cloud server, and data can be uploaded and downloaded via the wireless communication device.

The sensor in the intelligent cultivation apparatus may also periodically detect soil temperature, humidity and other information. When the soil is dehydrated, the controller automatically waters according to the suggestion on watering from the cultivation suggestion generator, and the wireless communication device will transmit the watering information to the user. When the soil is deficient, the controller automatically fertilizes according to the suggestion on fertilization from the cultivation suggestion generator. The cultivation suggestion generator may also generate a targeted cultivation suggestion on a placement location of the cultivation apparatus based on information such as flowers type and ambient light intensity, for example, placing exposed to the sun, etc., and transmitting the cultivation suggestion to the user.

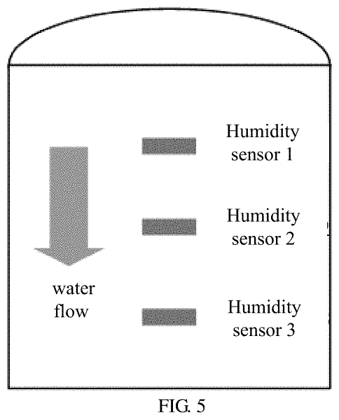

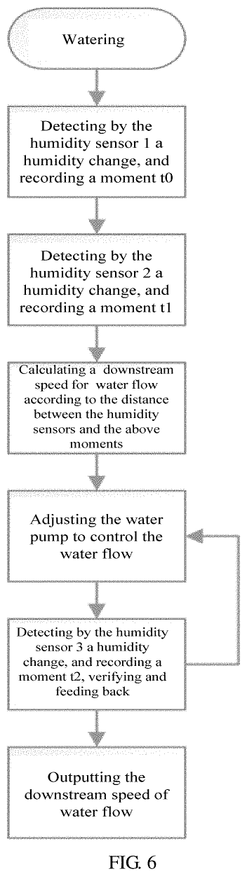

According to an embodiment of the present disclosure, the sensor may include a first humidity sensor and a second humidity sensor. FIG. 5 shows a schematic diagram of detecting a water absorption rate by using a humidity sensor according to an embodiment of the present disclosure. FIG. 6 shows a flow chart of detecting a water absorption rate by using a humidity sensor according to an embodiment of the present disclosure. Next, a progress in which the cultivation suggestion generator generates a targeted cultivation suggestion on watering in the intelligent cultivation apparatus will be described in detail below with reference to FIGS. 5 and 6.

As shown in FIG. 5, through the integrated design, positions of the humidity sensors (1, 2, and 3) in FIG. 5 can be accurately set. The humidity sensors whose position information is known are configured to detect a change of the soil humidity during the watering process. The controller can calculate parameters such as a water absorption rate of the soil. The cultivation suggestion generator can generate a targeted cultivation suggestion on the watering flow rate based on the parameters.

When the intelligent cultivation apparatus for flowers cultivation is initially used, a thickness of the soil and the soil parameters are unknown. If watering is carried out according to a fixed water flow, the soil may not absorb the water in time, and the water may flow over the edge of the flower pot. Therefore, the cultivation suggestion generator may be configured to generate a cultivation suggestion of being smaller than an initial flow velocity and an initial watering amount in the flowers cultivation database, and the controller is configured to control the water reservoir to water the flowers according to the cultivation suggestion.

As shown in FIG. 6, in the process of watering the cultivated flowers by the water reservoir, first, the humidity sensor 1 detects, as a first humidity sensor, the soil humidity data at a first location where it is positioned, and records a start moment t0. When the water flow continues to downstream, the humidity sensor 2 detects, as a second humidity sensor, the soil humidity data at a second location where it is positioned, and records a moment t1. The controller is configured to calculate the water flow downstream rate as the water absorption rate of the soil based on the soil humidity data respectively detected by the humidity sensor 1 and the humidity sensor 2, a distance between the first location and the second location, and a time interval between t0 and t1, wherein the distance between the first location and the second location is known in the design arrangement as shown in FIG. 5.

The calculated water absorption rate of the soil is one type of the flowers cultivation status information, and the cultivation suggestion generator may generate a targeted cultivation suggestion on the watering flow rate by using the flowers cultivation status information and in conjunction with the watering data in the flowers cultivation database. The controller is configured to adjust the parameter of the water pump 1 so as to water the flowers according to the cultivation suggestion. Therefore, the cultivation suggestion is generated based on the initial parameter in the cultivation database, in combination with the actual water absorption of the soil, which is more suitable for flowers cultivation.

On this basis, the humidity sensor 3 may detect the soil humidity data at a third location where it is positioned and record a moment t2 at the time of watering according to the cultivation suggestion. The controller is configured to verify the calculation result of the water absorption rate of the soil in combination with the distance therein between and the time interval as stated above, and corrects the water absorption rate of the soil.

In the subsequent cultivation process, the cultivation suggestion generator may also adjust the calculating parameters according to the corrected water absorption rate of the soil and the generated cultivation suggestion on watering, so as to continuously improve the intelligence level of the cultivation suggestion generator according to feedbacks of the actual situation.

When the soil is watered, the water absorption rate of the soil may be calculated by the process shown in FIG. 6. On this basis, the humidity sensor may also be configured to detect soil humidity data after watering the flowers, thereby calculating soil information for generating a targeted cultivation suggestion.

According to an embodiment of the present disclosure, the sensor in the intelligent cultivation apparatus further includes a third humidity sensor and a first temperature sensor.

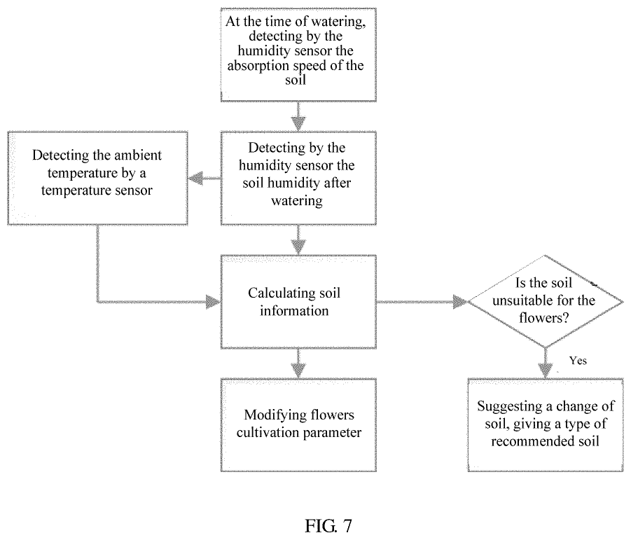

FIG. 7 shows a flow chart of calculating a drying rate of the soil according to an embodiment of the present disclosure, after using the humidity sensors described above to detect the water absorption rate during watering, any one of the humidity sensors 1, 2, 3 may be configured as a third humidity sensor that detects a change in soil humidity after watering. Specifically, for example, the humidity sensor 3 is configured to detect the soil humidity data at a certain moment after watering, and record a moment t3. After a period of time, the humidity sensor 3 is again configured to detect the soil humidity data, and record a moment t4.

Due to different compositions of different soils, their water absorption capacity and drainage capacity are also different. For example, the garden soil has good water absorption capacity but poor water drainage capacity. The garden soil can absorb a large amount of water and will have a high humility level after being watering sufficient water. The sandy soil and the humus soil with a strong permeability have strong drainage capacity and are significantly different from the garden soil. The water absorption capacity of the sandy soil and that of the humus soil are also different, which makes them have different soil humidity change with time after watering. The above data may be stored in the flowers cultivation database. Therefore, the cultivation suggestion generator may calculate the soil information such as parameters like the water absorption capacity and the gas permeability data of the soil according to the common data on the soil in the database and in combination with the data measured by the above sensors, generate a targeted cultivation suggestion on the soil, and update the relevant information in the flowers cultivation database. For example, by determining whether the soil is suitable for cultivating the flowers, a suggestion to replace the soil is made, and a type of recommended soil is generated. Alternatively, when it is determined that the soil permeability is poor, a suggestion of mixing humus soil, sandy soil, and the like may be generated, and when it is determined that the water absorption of the soil is poor, a suggestion of mixing garden soil or the like may be generated. The above soil information and the cultivation suggestion may be fed back to the user via the wireless communication device, or an updated flowers cultivation database may be uploaded to the cloud server.

As shown in FIG. 7, the temperature sensor may also be configured to detect the ambient temperature data, and then the controller is configured to combine the detected temperature data with the humidity data detected by the humidity sensor 3, thereby calculating a drying rate of the soil as the flowers cultivation status information. The drying rate indicates the rate of humidity absorption in the soil after watering which is affected by factors such as the watering amount and the ambient temperature. The cultivation suggestion generator is configured to generate a targeted cultivation suggestion on watering based on the calculated drying rate, the water absorption rate of the soil, and the soil parameters in the flowers cultivation database.

The cultivation suggestion generator may also combine the targeted cultivation suggestion with the flowers cultivation status information such as the drying rate of the soil so as to adjust the calculating parameter in the cultivation suggestion generator. For example, after the user replaces the soil composition, the cultivation suggestion generator may continually modify the calculating parameter on the watering amount according to the detected actual conditions, so that the generated targeted cultivation suggestion is more suitable for the current cultivation status.

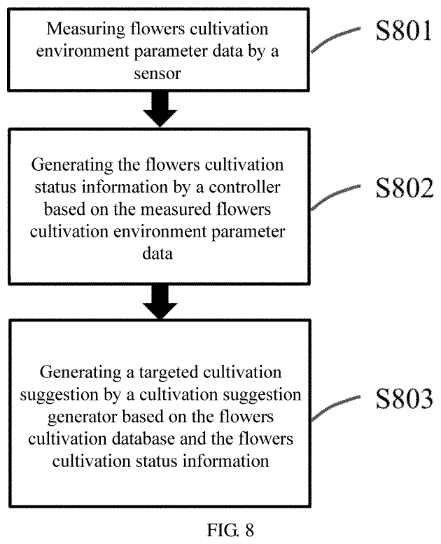

An embodiment of the present disclosure further provides an intelligent cultivation method, FIG. 8 shows a flow chart of the intelligent cultivation method. As shown in FIG. 8, in step S801, flowers cultivation environment parameter data is measured by a sensor, wherein the sensor may include one or more of a temperature sensor, a humidity sensor, a light intensity sensor and a soil nutrient sensor. Next, in step S802, the flowers cultivation status information is generated by the controller based at least on the measured flowers cultivation environment parameter data. In step S803, a targeted cultivation suggestion is generated by a cultivation suggestion generator based at least on the flowers cultivation database and the flowers cultivation status information.

The flowers cultivation database may include at least one of a flowers growth cycle, a suitable temperature, a suitable humidity, a suitable light intensity, a suitable soil parameter, a required nutrient component, a watering parameter and a fertilizing parameter. The targeted cultivation suggestion may include at least one of a suitable temperature range, a suitable humidity range, a watering period, a watering amount, a watering flow rate, a watering frequency, a nutrient solution applying amount, a fertilizing suggestion, a water absorption of the soil, a suitable soil, an illumination period and a suitable cultivation vessel size in practice for flowers cultivation. The controller is configured to control the water reservoir to water the flowers based on the targeted cultivation suggestion, and/or to control fertilization of the flowers by the fertilizer applicator so as to realize automatic intelligent cultivation of the flowers.

In the intelligent cultivation method, images of the flowers may also be captured by using a camera, and the cultivation suggestion generator is configured to generate a targeted cultivation suggestion based on the image of the flowers, the flowers cultivation database and the flowers cultivation status information.

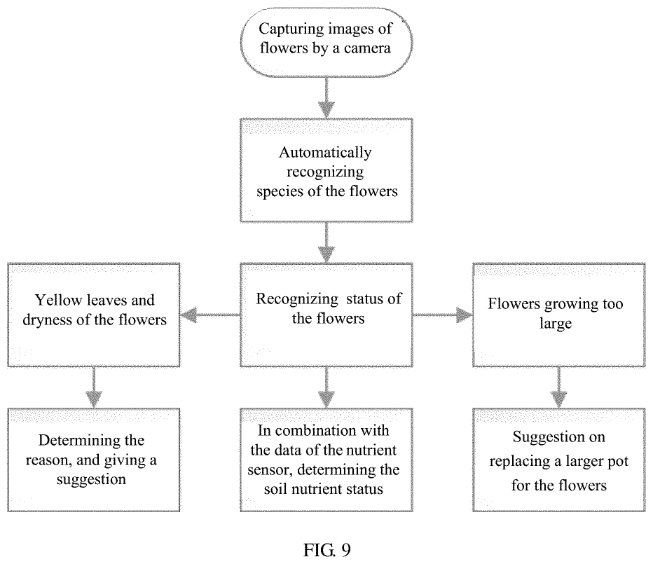

FIG. 9 shows a flow chart of generating a targeted cultivation suggestion based on images captured by a camera according to an embodiment of the present disclosure. First, the camera captures images of the flowers, and automatically completes recognition of species and cultivation status of the flowers through the captured images of the flowers. According to the recognized flowers status, the cultivation suggestion generator can combine the soil nutrient data detected by the nutrient sensor to determine the soil nutrient status and generate a targeted cultivation suggestion on fertilization. The size, status, etc. of the flowers may also be obtained through image processing. When the flowers grow too large, the cultivation suggestion generator may generate a cultivation suggestion of replacing a larger pot for the flowers. By means of obtaining status information such as yellow leaves and dryness of the flowers through image recognition, in combination with the data of such flowers in the flowers cultivation database and the flowers cultivation status information generated by the controller, the cultivation suggestion generator can further determine the reason of yellow leaves of the flowers, and generate a targeted cultivation suggestion.

The cultivation suggestion generator can generate a targeted cultivation suggestion based on the information in the flowers cultivation database and the flowers cultivation status information generated by the controller, or generate a targeted cultivation suggestion based on the flowers cultivation database, the flowers cultivation status information and the images of the flowers captured by the camera. Therefore, the generated targeted cultivation suggestion is generated based on the common data of flowers cultivation and the actual cultivation status, and can be more reasonably applied to the current cultivation status, thereby achieving more intelligent cultivation effects. In addition, the cultivation suggestion generator can further continuously adjust the calculating parameters of the cultivation suggestion generator in combination with the data measured by the sensor after the flowers is cultivated according to the targeted cultivation suggestion, and update the information in the flowers cultivation database, thus forming an intelligent cultivation process that makes continuous feedback and corrects parameters based on actual conditions.

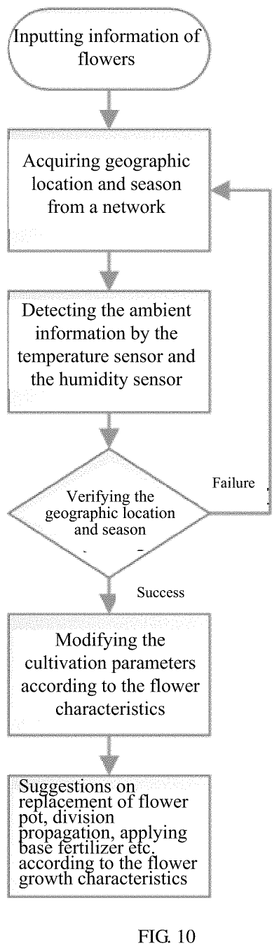

FIG. 10 shows a flow chart of intelligently cultivating plants according to geographic location and season according to an embodiment of the present disclosure. In the intelligent flowers cultivation process, geographic location information of the intelligent cultivation apparatus and season information during the flowers growing are acquired from a network by using a wireless communication device. In combination with the environment information detected by the sensor, such as ambient temperature and illumination time, the acquired geographical location and season can be verified to obtain accurate geographical location and season information. The cultivation suggestion generator is configured to generate targeted cultivation suggestion on flowers growth based on the data in the flowers cultivation database, the flowers cultivation status information, and the acquired geographic location and season information, wherein the targeted cultivation suggestion on flowers growth serves as a targeted cultivation suggestion on plants growth. For example, the targeted cultivation suggestion may be replacing the flower pot, the soil, a division propagation, or the suggestion that the fertilizer should be top-dressed or not, so that the flowers can be cultivated intelligently according to the actual environment. The data in the flowers cultivation database may be, for example, flowers growth cycle characteristics. The flowers cultivation status information may be data such as the temperature, humidity, light, nutrient information, or water absorption rate of the soil detected by the sensor.

In the intelligent cultivation method provided according to an embodiment of the present disclosure, a wireless communication device may also be configured to connect to a cloud server, for downloading the flowers cultivation database and uploading an updated flowers cultivation database.

In the intelligent cultivation method provided according to an embodiment of the present disclosure, the wireless communication device may also be configured to transmit the flowers cultivation status information generated by the controller and/or the targeted cultivation suggestion generated by the cultivation suggestion generator to the user terminal, so that the user can receive information on flowers cultivation in real time.

In the intelligent cultivation method provided according to an embodiment of the present disclosure, the wireless communication device may also be configured to receive an electronic album transmitted by the user terminal, and the controller is configured to control the display screen to display the electronic album transmitted from the user terminal.

In the intelligent cultivation method provided according to an embodiment of the present disclosure, the wireless communication device may also be configured to receive a command for watering and/or fertilizing the flowers transmitted from the user terminal, and the controller is configured to control the water storage to water the flowers and control the fertilizer applicator to fertilize the flowers according to the command received by the wireless communication device, so as to achieve intelligent cultivation of flowers according to the user's command.

In the intelligent cultivation method provided according to an embodiment of the present disclosure, wherein the wireless communication device includes a first operating mode and a second operating mode. In the first operating mode, the wireless communication device receives from the cloud server the data transmitted by the user terminal to the cloud server; and in the second operating mode, the wireless communication device directly receives data from the user terminal.

According to an embodiment of the present disclosure, in the process of intelligent cultivation of flowers, the cultivation suggestion generator may also be configured to combine the targeted cultivation suggestion with the flowers cultivation status information, adjust the calculating parameter of the cultivation suggestion generator and update the flowers cultivation database.

An embodiment of the present disclosure further provides an intelligent cultivation system comprising the intelligent cultivation apparatus as described above, and intelligent cultivation system can be used for intelligently cultivating plants and the like. The intelligent cultivation system further comprises a user terminal that can communicate with the intelligent cultivation apparatus over a wireless network, for example, through a router.

The intelligent cultivation system further comprises a cloud server, and the cloud server communicates with the intelligent cultivation apparatus and the user terminal through a wireless network.

The present disclosure provides an intelligent cultivation apparatus, method and system capable of measuring plants cultivation environment parameters by using a sensor, generating plants cultivation status information based at least on the measured plants cultivation environment parameter data, and generating the targeted cultivation suggestion by using the cultivation suggestion generator based at least on the plants cultivation database and the plants cultivation status information. The cultivation suggestion generator can also adjust the calculating parameter for generating the cultivation suggestion based on the generated cultivation suggestion and the calculated plants cultivation status information, and update the plants cultivation database. The intelligent cultivation apparatus, method and system can also use the controller to control the watering of the water reservoir and control the fertilization of the fertilizer according to the targeted cultivation suggestion, so as to realize intelligent cultivation of the plant, and connect with the cloud server or the user terminal by using the wireless communication device, for feeding back the cultivation suggestion and cultivation status to the user, or receiving the cultivation command and the electronic album transmitted by the user, and display the pictures of plants or the electronic album by using the display screen.

The above-described intelligent cultivation apparatus, method and system may be applied to the cultivation of other plants, for example, ornamental potted plants, vegetables, etc., which constitutes other embodiments according to the present disclosure, and all falls into the scope of the claims of the present disclosure.

The above description is only specific embodiments of the present disclosure, and is not intended to limit the scope of the present disclosure. The protection scope of the disclosure should be determined by the appended claims.

1: An intelligent cultivation apparatus, comprising:
a sensor, configured to measure plants cultivation environment parameter data;
a controller, configured to generate plants cultivation status information based at least on the measured plants cultivation environment parameter data; and
a cultivation suggestion generator, configured to generate a targeted cultivation suggestion based at least on a plants cultivation database and the plants cultivation status information.

2: The intelligent cultivation apparatus according to claim 1, further comprises a camera configured for capturing images of the plants, wherein the cultivation suggestion generator generates the targeted cultivation suggestion based on the images of the plants, the plants cultivation database and the plants cultivation status information.

3: The intelligent cultivation apparatus according to claim 1, wherein the cultivation suggestion generator further configured to combine the targeted cultivation suggestion with the plants cultivation status information, for adjusting calculating parameters of the cultivation suggestion generator and updating the plants cultivation database.

4: The intelligent cultivation apparatus according to claim 1, wherein
the sensor includes one or more of a temperature sensor, a humidity sensor, a light intensity sensor and a soil nutrient sensor;
the plants cultivation database includes at least one of a plants growth cycle, a suitable temperature, a suitable humidity, a suitable light intensity, a suitable soil parameter, a required nutrient component, a watering parameter and a fertilizing parameter;
the controller further controls a water reservoir to water plants and/or controls a fertilizer applicator to fertilize plants based on the targeted cultivation suggestion.

5: The intelligent cultivation apparatus according to claim 1, further comprising:
a wireless communication device which includes a first operating mode and a second operating mode: in the first operating mode, the wireless communication device is connected, as a wireless access point, to a user terminal so as to be configured through the user terminal; in the second operating mode, the wireless communication device is connected to a cloud server, so as to download the plants cultivation database and uploading an updated plants cultivation database.

6: The intelligent cultivation apparatus according to claim 1, further comprising: a display screen.

7: The intelligent cultivation apparatus according to claim 1, wherein the sensor includes a first humidity sensor and a second humidity sensor,
at a first moment in the watering process, first humidity data is measured at a first location by using the first humidity sensor;
at a second moment in the watering process, second humidity data is measured at a second location by using the second humidity sensor;
a water absorption rate of the soil is calculated by using the controller based on the first humidity data, the second humidity data, a distance between the first location and the second location as well as a time interval between the first moment and the second moment, as the plants cultivation status information;
a targeted cultivation suggestion on watering is generated by using the cultivation suggestion generator based on the plants cultivation database and the water absorption rate of the soil.

8: The intelligent cultivation apparatus according to claim 7, wherein the sensor further includes a third humidity sensor and a first temperature sensor,
at a third moment after watering, third humidity data is measured by using the third humidity sensor;
at a fourth moment after watering, fourth humidity data is measured by using the third humidity sensor;
temperature data after watering is measured by using the first temperature sensor;
a drying rate of the soil is calculated by using the controller based on the third humidity data, the fourth humidity data, a time interval between the third moment and the fourth moment as well as the temperature data, as the plants cultivation status information;
a targeted cultivation suggestion on a watering amount is generated by using the cultivation suggestion generator based on the plants cultivation database, the water absorption rate of the soil and the drying rate of the soil.

9: An intelligent cultivation method for the intelligent cultivation apparatus according to claim 1, comprising:
measuring, by a sensor, plants cultivation environment parameter data;
generating, by a controller, plants cultivation status information based at least on the measured plants cultivation environment parameter data; and
generating, by a cultivation suggestion generator, a targeted cultivation suggestion based at least on a plants cultivation database and the plants cultivation status information.

10: The intelligent cultivation method according to claim 9, further comprising:
capturing, by a camera, images of the plants, wherein the cultivation suggestion generator generates the targeted cultivation suggestion based on the images of the plants, the plants cultivation database and the plants cultivation status information.

11: The intelligent cultivation method according to claim 9, further comprising:
combining, by the cultivation suggestion generator, the targeted cultivation suggestion with the plants cultivation status information, for adjusting a calculating parameter of the cultivation suggestion generator and updating the plants cultivation database.

12: The intelligent cultivation method according to claim 9, further comprising:
acquiring, by a wireless communication device, from a wireless network, geographical location information of the intelligent cultivation apparatus and season information for cultivation,
wherein the cultivation suggestion generator generates a targeted cultivation suggestion on plants growth based on the plants cultivation database, the plants cultivation status information as well as the geographic location information and the season information.

13: The intelligent cultivation method according to claim 9, wherein
the plants cultivation database includes at least one of a plants growth cycle, a suitable temperature, a suitable humidity, a suitable light intensity, a suitable soil parameter, a required nutrient component, a watering parameter and a fertilizing parameter;
the targeted cultivation suggestion includes at least one of a suitable temperature range, a suitable humidity range, a watering period, a watering amount, a watering flow rate, a watering frequency, a nutrient solution applying amount, a fertilizing suggestion, a water absorption of the soil, a suitable soil, an illumination period and a suitable cultivation vessel size for plants cultivation in practice,
wherein the controller controls a water reservoir to water plants and/or controls a fertilizer applicator to fertilize plants based on the targeted cultivation suggestion.

14: The intelligent cultivation method according to claim 12, further comprising:
connecting the wireless communication device to a cloud server, for downloading the plants cultivation database and uploading an updated plants cultivation database.

15: The intelligent cultivation method according to claim 12, further comprising:
transmitting, by the wireless communication device, to a user terminal, the plants cultivation status information generated by the controller and/or the targeted cultivation suggestion generated by the cultivation suggestion generator.

16: The intelligent cultivation method according to claim 12, further comprising:
receiving, by the wireless communication device, an electronic album transmitted from the user terminal; and
controlling, by the controller, a display screen to display the electronic album transmitted from the user terminal.

17: The intelligent cultivation method according to claim 12, further comprising:
receiving, by the wireless communication device, from the cloud server, data transmitted from the user terminal to the cloud server, and/or directly receiving data from the user terminal.

18: The intelligent cultivation method according to claim 12, further comprising:
receiving, by the wireless communication device, a command transmitted from the user terminal to water and/or fertilize plants; and
controlling, by the controller, the water reservoir to water plants and/or the fertilizer applicator to fertilize plants, according to the command received by the wireless communication device.

19: An intelligent cultivation system comprising the intelligent cultivation apparatus according to claim 1, further comprising a user terminal, the user terminal configured to communicate with the intelligent cultivation apparatus over a wireless network.

20: The intelligent cultivation system according to claim 19, further comprising a cloud server, the cloud server configured to communicate with the intelligent cultivation apparatus and the user terminal over a wireless network.
